(19) United States
(12) Patent Application Publication
(10) Pub. No.: US 2011/0208650 A1
(43) Pub. Date: Aug. 25, 2011

(54) Systems and Methods for Paying Invoices

(76) Inventors: John G. McGill, Naperville, IL (US); William J. Dupre, Downers Grove, IL (US); George F. D. Wishart, Winnetka, IL (US)

(21) Appl. No.: 13/012,793

(22) Filed: Jan. 24, 2011

Related U.S. Application Data
(60) Provisional application No. 61/336,548, filed on Jan. 23, 2010.

(51) Int. Cl. G06Q 40/00

(52) U.S. Cl. 705/40

(57) ABSTRACT

An invoice payment service enables a method for paying an invoice at a retail store. The invoice identifies a payment amount owed by a customer to a service provider for use of one or more services. The payment process is enabled by assigning a unique customer identification code to the customer and assigning a unique PLU number to the service provider. Both the customer identification code and PLU number are entered into a point of sale system of the retail store and the payment amount is collected. The customer identification code and PLU number are then transmitted to the invoice payment service for use in causing a financial institution to complete a fund transfer by which the service provider receives the payment amount tendered by the customer at the retail store.

### RELATED APPLICATION

This patent claims priority from U.S. Provisional Application Ser. No. 61/336,548, entitled “Systems and Methods for Paying Invoices” and filed on Jan. 23, 2010. U.S. Provisional Application Ser. No. 61/336,548 is hereby incorporated by reference in its entirety.

### TECHNICAL FIELD

The present invention relates to systems and methods permitting a customer to pay an invoice, such as a utility invoice, at a retail outlet, such as a grocery store.

### BRIEF DESCRIPTION OF THE DRAWINGS

The detailed description is described with reference to the following set of drawings. The same reference numerals provided on different drawings indicates the same or similar items. Other advantages and aspects of the invention will become apparent upon reading the following description of the drawings and detailed description.

FIG. 1 is a block diagram showing a system that can be used to perform a payment transaction process according to at least some of the example techniques described herein.

FIG. 2 illustrates a number of data sets, generally represented in table format, that are collected during the payment transaction process performed by the example system of FIG. 1.

FIG. 3 is a process flow diagram showing a set of blocks to be executed to implement an example invoice payment transaction according to the example techniques described herein.

FIG. 4 is a process flow diagram showing a set of blocks to modify a conventional retail payment processing system to implement an example invoice payment transaction according to the example techniques described herein.

FIG. 5 is a block diagram illustrating a representative computing device. The representative device may be a part of the exemplary system show in FIG. 1.

### DETAILED DESCRIPTION

While this invention is susceptible of embodiment in many different forms, there are shown in the drawings and will herein be described in detail, examples of the invention with the understanding that the present disclosure is to be considered as an exemplification of the principles of the invention and is not intended to limit the broad aspect of the invention to the examples illustrated.

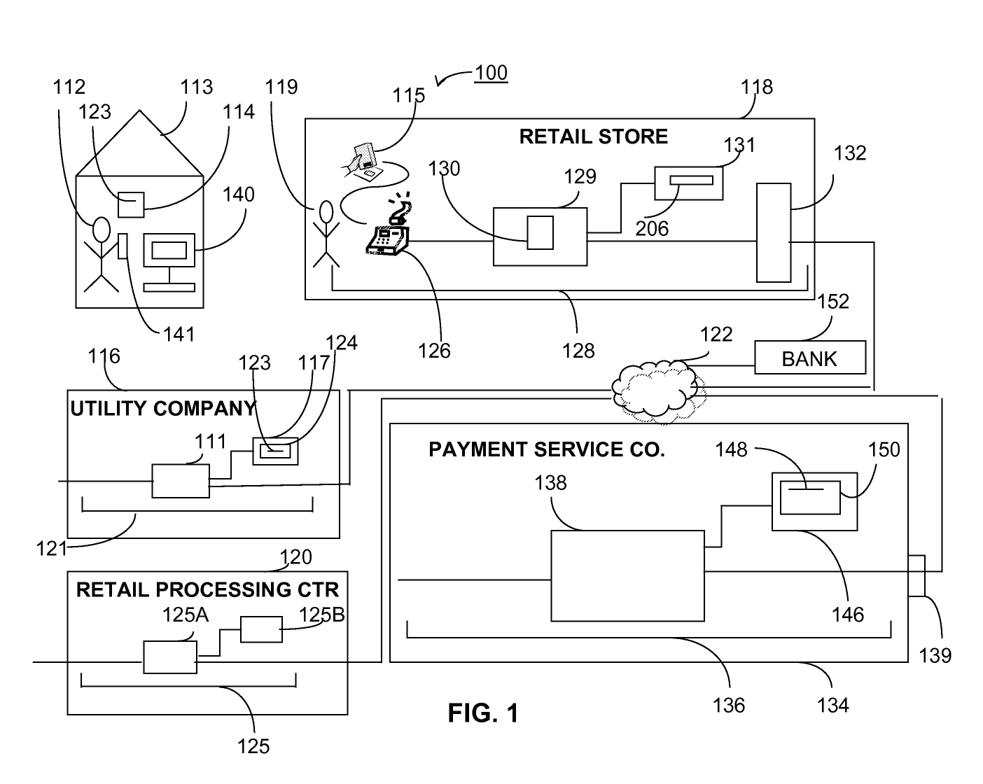

Described herein with reference to the FIGS. 1, 2, 3A, 3B, 4 and 5, are example invoice payment processing systems and methods by which a customer of a service provider can pay an invoice issued by the service provider at a retail store. An invoice payment service assigns a customer identification code to uniquely represent the customer and to be used as an index to reference a set of information collected from the customer. A conventional payment processing system at the retail store is modified to recognize and process a special product look-up (PLU) number assigned to represent the service provider. Upon entry of the special PLU number into a cashier terminal coupled to the payment processing system, an invoice payment process is initiated and causes the capture of the unique customer identification code and a payment amount to be paid toward the invoice. The captured information is subsequently transmitted to an invoice payment service where the PLU number and the customer identification code are used to retrieve information needed to instruct a fund transaction management entity, such as a bank, to forward the payment amount to the service provider on behalf of the customer.

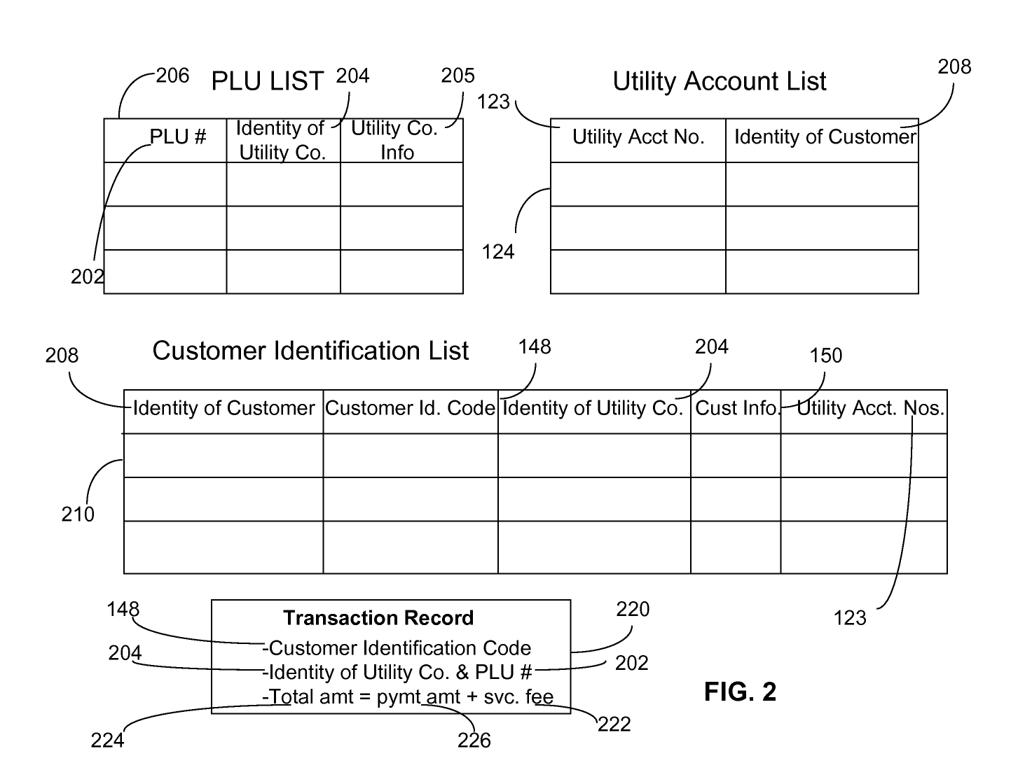

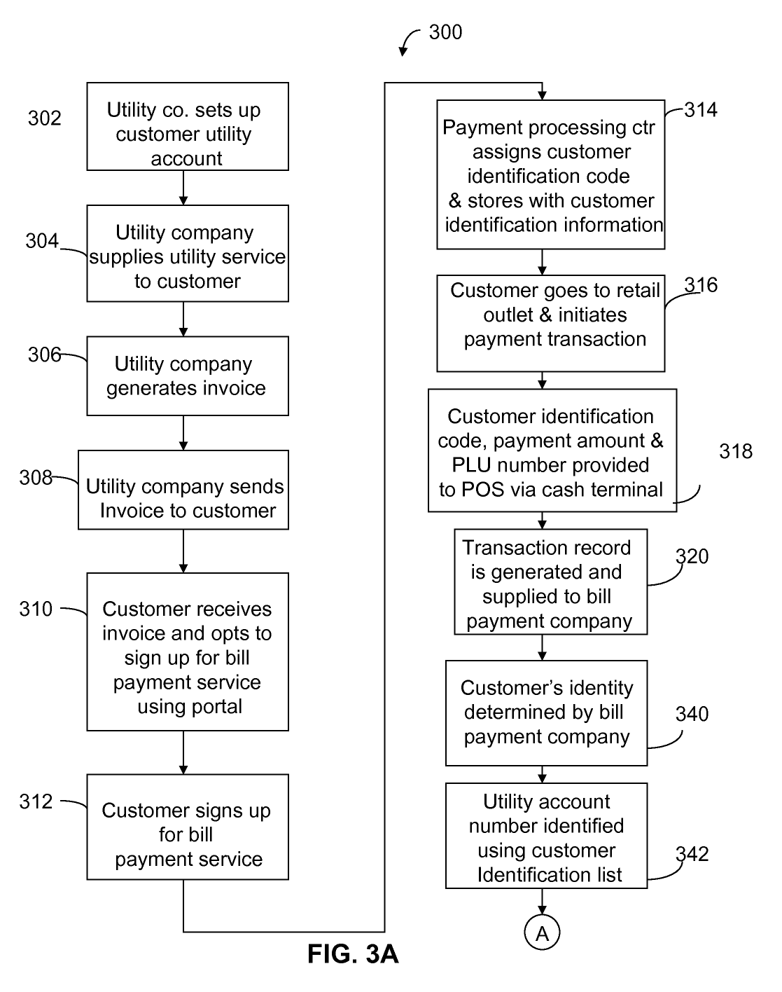

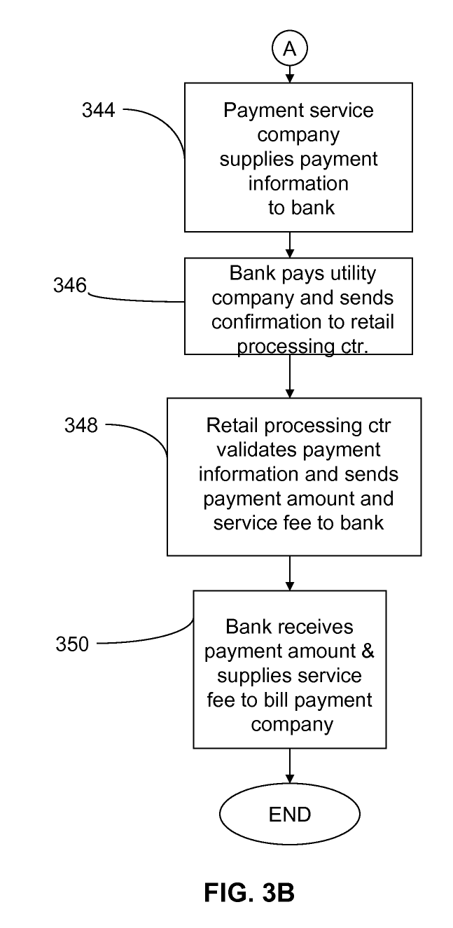

FIG. 1 illustrates an example system 100 for enabling a customer/billee 112, such as an individual, to pay an invoice 114 generated by a biller 116 at a retail store 118. In one example embodiment, the biller 116 is a service provider, such as a utility company 116, that supplies a utility service to the customer 112 at a location associated with the customer 112, such as the customer's dwelling or residence 113. The utility company 116 includes a utility processing system 121 having one or more processors 111 coupled to one or more utility memory devices 117. The utility processing system 121, which is coupled to the internet 122, processes, stores and communicates information and performs any of a variety of tasks required to provide the utility service to the customer's residence 113. As will be described further hereinbelow with reference to FIGS. 2, 3A and 3B, a Product Look Up (PLU) number 202 is assigned to uniquely represent the utility company 116. Other utility companies (not shown) are also each assigned a corresponding unique PLU number 202 such that each of the utility companies 116 can be identified using its corresponding PLU number 202.

Referring also to FIG. 2, when the customer 112 informs the utility company 116 of his/her desire to receive utility service, the utility company 116 opens a customer account for use in tracking the amount of utility service provided to the customer 112 and for billing purposes. The utility processor 111 assigns a utility account number 123, which may be formatted as, for example, a bar code 123 to represent the customer's utility account. The utility account number 123 is stored by the utility processor 111 in the memory 117. According to one example embodiment, the utility account number 123 is stored as part of an example utility account list 124 that contains identifying information, referred to as the identity 208, for each customer 112 and each customer's corresponding utility account number 123. Upon adding a new utility account number 123 to the utility account list 124, the utility processing system 121 causes the utility account list 124 to be transmitted to a payment service company 134 for use in the payment process as is described further hereinbelow. Instead of transmitting the utility account list 124 to the payment service company 134 each time the list is updated, the utility account list 124 may be transmitted to the payment service company 134 at any desired time interval. In another example, the utility company 116 need not transmit the utility account list 124 to the payment service company 134, in which case the payment service company 134 will receive the utility account number 123 from the customer 112 during a payment service sign-up/enrollment process described herein.

It should be understood that the processes by which the customer enlists and receives the utility service are intended to be exemplary and that the way in which these example processes are performed may vary in any number of ways without affecting the invoice payment process described herein.

Referring still to FIG. 1, the retail store 118 may be one of any number of retail stores associated with, for example, a retail chain of outlets (not shown) that receives centralized services, such as accounting services, from a retail processing center 120. The retail processing center 120 includes a retail processing system 125 comprising one or more processors 125A coupled to one or more memory devices 125B. The retail processing system 125, which is intended to be illustrative of a conventional retail processing center, is configured to process, store, and communicate information and perform any of a variety of processing tasks required to operate the retail chain. The retail processing system 125 is coupled to the internet 122 to enable communication with any of the retail stores 118 (only one of which is shown in FIG. 1).

Each of the retail stores 118 typically includes a retail store processing system 128 which has one or more cashier's terminals 126 (only one of which is shown in FIG. 1) that are coupled to any number of processors 129 coupled to one or more memory devices 131 for processing, storing and communicating information. At least a portion of the retail store processors 129 are configured to operate as a conventional point-of-sale (POS) controller 130 which is coupled between the cashier's terminals 126 and a communication server 132 such as, for example, an ftp server. The ftp server 132 enables the transfer of information between the retail store 118 and the payment service company 134 via any electronic network such as, for example, the internet 122. The retail processing center 120 may also communicate with the payment service company 134 via the internet 122 and any communications between the payment service company 134 and one or more financial institutions 152, such as a set of banks 152, may occur via the internet 122. Alternatively, one or more of the communication channels described above may occur via dedicated channels outside of the internet 122. Indeed, any communication between the components of the system 100 may occur using any form of electronic information transfer.

The retail store processing system 128 is intended to be illustrative of a conventional retail processing center that has been modified to perform a set of blocks that enable a portion of the invoice payment process, as is described more fully herein.

As is described further herein with reference to FIG. 2, an example PLU list 206 shown in FIG. 2 is stored in the retail store memory 131 of the retail store processing system 128 and includes identifying information, referred to as the identity 204, for each utility company 116 (only of which is shown) and each utilities company's corresponding PLU number 202. The PLU list 206 additionally includes a corresponding set of utility company information 205 for each utility 116 as described further herein.

The payment service company 134 includes a payment service processing system 136 having a set of payment service processors 138 coupled to one or more payment service memory devices 146 for processing, storing and communicating information and for performing any of a variety of tasks needed to provide the payment service. The payment service processing system 136 further includes a portal 139 at which the customer 112 may opt to sign up to use invoice the payment service. The portal 139 may be implemented using any communication tool that enables communication between the payment service company 134 and the customer 112 including, for example, a website, a call center, a text messaging system, an e-mail system, etc. The customer 112 has access to the portal 139 via any of a number of communication devices, including for example, a personal computer 140 (see FIG. 1), a land based or mobile telephone 141 (see FIG. 1), etc.

Upon opting to use the payment service, the payment service company 134 assigns the customer 112 a unique customer identification code 148 for use in the invoice payment process as is described further with reference to FIG. 3. The unique customer identification code 148 along with the identity 208 of the corresponding customer 112 (see FIG. 1) and the identity 204 of the utility company 116 is added to an example customer identification list 210 stored in the payment service memory 146. The customer 112 may opt to use the payment service to pay utility invoices 114 issued by any number of different utility companies 116. For example, the portal 139 may prompt the customer 112 to identify the number of utility companies 116 to be paid through the payment service company 134. The payment service processing system 136 may then cause the portal 139 to display, for example, a table (not shown) having data fields for entering information pertaining to any of the utility companies 116 identified by the customer 112. The fields may be configured for entry of any of the information identified as being stored in the customer identification table 210 or any other desired information. The information entered by the customer 112 into the data fields is ultimately stored in the payment service memory 146 in a manner that allows the retrieval of information pertaining to each customer 112 including, for example, information about the utility companies 116 used by the customer 112 and each corresponding utility account number 123.

FIG. 3, which includes FIGS. 3A and 3B, illustrates an example method 300 for enabling payment of the utility invoice 114 at the retail store 118. The method 300 is described with reference to a set of numbered blocks which represent various tasks performed during the method. As will be appreciated by one of ordinary skill in the art, the method blocks that are performed by any of the processors described with respect to FIG. 1 may be implemented using software instructions, hardware or any combination thereof. Software instructions and hardware used to perform the tasks represented by the method blocks may take any of a number of different forms and may be implemented using any of a variety of software languages and/or hardware configurations. As will further be appreciated by one of ordinary skill in the art, the method may be performed using a fewer or greater number of blocks provided that the overall objectives of each of the blocks are met in way that enables the invoice payment process. Further, although the order in which the blocks are performed is generally represented by the flow chart of FIGS. 3A and 3B, the order in which many of the blocks are performed may be varied to implement the invoice payment process.

The method 300 begins at block 302 when, as described with reference to FIG. 1, the customer 112 chooses to receive utility service from the utility company 116 (see FIG. 1). The utility company 116 responds by setting up the customer account which is represented by the utility account number 123. At the block 302, the utility processing system 121 adds the utility account number 123 and the identity 208 of the corresponding customer 112 to the utility account list 124 stored in the utility processing system memory 117. Still referring to block 302, the utility processing system 121 subsequently transmits the utility account list 124 to the payment service company 134 at any desired interval. However, as described earlier, the utility account list 124 need not be transmitted to enable the invoice payment process described herein.

Next, at a block 304, the utility service company 116 supplies the utility service to, for example, the customer's residence 113. To inform the customer 112 of the utility fee owed to the utility company 116 for the usage of the utility service, at block 306, the utility company 116 generates the invoice 114 that includes the utility account number 123 in a format such as, for example, a universal product code A (UPC-A) bar code that is able to be scanned and recognized by any conventional retail store 118 processing system 128. The utility account number 123 may additionally be supplied on the invoice 114 in, for example, a human readable format such as a numeric sequence or as a code formatted in a magnetic strip embedded on a card. The invoice 114 further identifies a utility fee equal to the cost of the utility service supplied to the customer 112 and identifies the utility company 116. The invoice 114 is subsequently transmitted to the customer 112, at block 308, via any of a number of communication channels such as, for example, U.S. mail service, e-mail, telephone, text messaging, etc. The blocks 302, 304, 306 and 308 describe example processes/tasks by which the utility service is supplied to the customer 112 and tracked for billing/invoicing purposes. As will be understood by one having ordinary skill in the art, these example processes are not required to be implemented in the exact manner described to enable the invoice payment process.

Proceeding to a block 310, upon receipt of the invoice 114, for example, the customer 112 opts to sign up for the invoice payment service via the portal 139. The portal 139, as described with reference to FIG. 1, may be implemented as, for example, a website, a call center, an e-mail service, a text messaging service, etc. Thus, depending on the form of the portal 139, the customer 112 signs up by, for example, visiting a website of the payment service company 134, phoning a call center operated by the payment service company 134, using e-mail or text messaging to correspond with the payment service company 134, etc.

It should be understood that the customer 112 may opt to sign up for the invoice payment service prior to receipt of the invoice 114 and that the customer 112 may sign up at any point in time. In one example system, after signing up for the invoice payment service, the customer 112 may update the information supplied to the payment service company 134 during sign up to include, for example, additional utility companies to be paid through the service or to provide revised information about the customer 112, etc. In another example system, the customer 112 may attempt to pay a utility invoice 114 at the retail store 118 before the customer 112 has entered the corresponding utility company 116 into the payment service processing system 136 via the portal 139. In such a case, the retail store 118 will proceed to process the payment in the manner described herein provided that the utility company 116 has been assigned a unique PLU number 202. The payment service processing system 136 upon receiving the corresponding payment information accesses the customer identification list 210 and determines that a utility account number 123 corresponding to that customer 112 is not known for that utility company 116. In this example, the payment service processing system 136 may rely on the information contained in the utility account list 124 supplied by the utility company 116, if available, to identify the utility account number 123. Or the payment service processing system 136 may, for example, send a message via portal 139 to the customer 112 requesting that the customer supply the utility account number 123 toward which the payment is to be applied.

At a block 312, the customer proceeds to sign up for the utility payment service and the payment service company 134 collects a set of customer information 150 from the customer 112 including the customer's name and contact information, identifying information about the utility company 116 used by the customer 112 and the utility account number 123. Any of a variety of other customer information may also be collected such as, the customer's communication preferences, customer shopping preferences, etc. At a block 314, the payment service processing system 136 assigns to the customer 112 a customer identification code 148 that uniquely represents the customer 112. Also at the block 314, the payment service processing system 136 stores the customer identification code 148 along with the corresponding customer information 150, the identity 204 of the utility company 116 and the utility account number 123, if available. In one example, this information is stored in the payment service memory 146 in format corresponding, for example, to the customer identification list 210 described above. Additional information, such as the PLU number 202 that uniquely identifies the utility company 116 may also be stored in the customer identification list 210. In the payment service memory 146, the payment service processor 138 also stores the PLU list 206 containing each utility company PLU number 202, the identity 204 of each utility company 116, and a set of corresponding utility company information 205 such as, for example, the name of the utility company 116, contact information for the utility, such as a phone number and/or address and any other data that may be relevant to paying the utility company 116. The invoice payment service company 134 may have collected the corresponding utility information 205 from the utility companies 116 or from public sources of information.

In another example, the customer 112 need not wait for the utility invoice 114 to arrive before signing up for the payment processing service. In such a case, however, during the sign up process, the customer 112 may not yet be informed of the utility-assigned customer account number 123 used to track the customer's utility service usage. To enable enrollment in the payment processing service without a utility account number 123, the payment service processor 138 permits the sign up process to proceed absent entry of such information. The customer 112 may, at any later time, update the customer information 150 supplied to the payment service company 134 via the portal 139 to thereby supply the utility account number 123 to the payment service company 134. In the event that an invoice 114 is presented for payment at the retail store 118 before the customer 112 has supplied the payment service company 134 with the utility account number 123, the payment service company 134 can use the utility account list 124 supplied by the utility company 116 to enable payment processing of the invoice 114. In still another embodiment, the payment processing service may permit payment processing to proceed absent the utility account number 123 thereby relying on the utility company 116 to determine the account to which the payment should be credited using only the identity of the customer 112 as supplied by the payment service company 134 during the invoice payment transaction. In yet another embodiment, the customer 112 knows the utility account number 123 prior to the enrollment process and so provides the utility account number 123 to the payment service company 134 at that time. The collected information is stored in the customer identification list 210 such that the customer identification code 148 corresponds to the utility account number 123 and can be used at any later time to identify the utility account number 123.

The customer identification code 148 is supplied to the customer 112 in any machine readable code such as, for example, a UPC barcode and is provided to the customer 112 on any of a variety of media including, for example, on a web page that is printed by the customer using the computer system 140, on a smartphone image displayed by the phone 141, or on a plastic or paper card (not shown) which may be mailed to the customer 112 via, for example, the U.S. postal system. In one example invoice payment processing system, the customer identification code 148 is provided to the customer 112 as a human readable sequence of alpha numeric characters on any medium capable of displaying such characters.

In at least one embodiment, the payment service company 134 may determine whether the retail store 118 at which the customer shops has issued the customer 112 a customer loyalty card on which a machine readable identifying code, such as a UPC bar code, is displayed. If the customer 112 has such a customer loyalty card, then the customer may be prompted during, for example, the enrollment process to supply the information shown on the customer loyalty card to the payment service company 134. Subsequently, the payment service company 134 converts the customer identification code 148 to the customer loyalty code/number for use in the invoice payment process described herein. In instances where the customer's loyalty card information is used to represent the customer identification number 148, the retailer that issued the loyalty card may, but need not, be a participant in the payment service offered by the payment service company 134. In the event that a retailer A (not shown) that issued the customer loyalty card does not participate in the payment service, the payment service company 134 may still utilize the retailer A loyalty card information to represent the customer identification code 148 of the customer 112. In such a case, the payment service company 134 instructs the customer 112 to provide the customer loyalty card issued by retailer A to the participating retailer B (not shown) during invoice payment transactions occurring at retailer B (not shown).

After enrolling in the payment service, at a block 316, the customer 112 goes to one of the cashier terminals 126 located at the retail store 118 and indicates a desire to pay the utility invoice 114. Then, at a block 318, the cashier 119 collects information from the customer 112 that identifies the utility company 116 to be paid. For example, the customer 112 might supply the invoice 114 to the cashier 119 who reviews the printed information on the invoice 114 to identify the name of the utility company 116 or the customer 112 may simply state the name of the utility company 116. Once the identity of the utility company 116 is known, the cashier 119 then identifies the PLU number 202 corresponding to the specific utility company 116 used by the customer 112. Referring also to FIG. 2, in one example, the cashier 119 identifies the PLU number 202 by consulting a printed copy of the PLU list 206 containing the identity 204 of each utility company 116 that uses the invoice payment service and the utility's corresponding PLU number 202. In another embodiment, the PLU number 202 representing the utility company 116 may be supplied on the customer's utility invoice 114 itself such that the cashier 119 need only review the customer's utility invoice 114 to identify its corresponding PLU number 202. After entry of the PLU number 202 at the cashier terminal 126, the PLU number 202 is supplied to the retail store processing system 128.

Still referring to block 318, after entering the PLU number 202 into the cashier's terminal 126 either by manual key entry or the scanning device 115, provided that the PLU number 202 is supplied in a scannable format, the cashier 119 then uses the scanner 115 to scan customer identification code 148 which may be formatted as a UPC bar code or in any other format. Upon being scanned, the customer identification code 148 is supplied to the retail store processing system 128. As described with reference to FIG. 1, the UPC bar code 148 is scanned from the medium on which it was supplied to the customer 112 which may include a plastic or paper card, a customer loyalty card, an image printed from a website, an image displayed on a smartphone 141, or from any other device or medium capable of displaying a UPC bar code.

Also at the block 318, the customer 112 informs the cashier 119 of an amount of money 226 to be paid to the utility company 116. The payment amount 226 may equal all or less than the utility fee owed by the customer 112 to the utility company 116. The cashier 119 then enters the payment amount 226 into the cashier's terminal 126. The POS controller 130 receives the information entered at the cashier's terminal 126 including the PLU number 202, the customer identification code 148 and the payment amount 226. The POS controller 130 determines a total amount 224 by adding a predetermined service fee 222 to the payment amount 226 to be paid and then provides the total amount 224 to the cashier's terminal 126 for use in informing the customer 112 of the total amount 224 due. As can be appreciated upon review of the operations performed at the block 318, in at least one example, the customer 112 need only have his customer identification code 148 to pay the invoice at the retail store 118. In one example, the payment transaction can proceed if the customer 112 states the name of the utility company 116, states his customer identification code 148, provided that the code 148 is supplied to the customer in a human readable format, and identifies the payment amount 226 to the cashier 119. Thus, the customer 112 is not required to carry the invoice 114 itself or the card, for example, on which the customer's identification code 148 is displayed to the retail store 118 in order to utilize the invoice payment service.

The predetermined service fee 222 may be calculated by the payment service company 134 and may vary depending on the utility company 116 being paid and/or any other number of factors. In one example embodiment, the payment service processing system 136 sends information identifying the service fee 222 to the retail store processing system 128 for use in determining the total amount 224. If different service fees 222 are to be applied when processing invoices issued by different utility companies 116, then such service fee 222 information is also supplied by the payment service processing system 136 to the retail store processing system 128. In one example, the service fee 222 may be adjusted by the retail store 118. In another example, a portion of the service fee 222 may be paid to the bank 152.

Next, at a block 320, the POS controller 130 creates a transaction record 220 containing the total amount 224, the PLU number 202 and the customer identification code 148 and stores the transaction record 220 in the retail store memory 131. The identity of the utility company 116, as determined by the POS controller 130 via accessing the PLU list 206 stored in the retail store memory 131, may also be included in the transaction record 220. As described previously with reference to FIG. 2, the PLU list 206 stored in the retail store memory 131 includes the identity 204 of each local utility company 116 and its corresponding PLU number 202. In contrast, the PLU list 206 stored in the payment service memory 146 of the payment service processing system 136 may include not only the identities 204 of local utility companies 116 but also the identities of utility companies located anywhere in the nation, or world. The PLU list 206 stored in the retail store 118 may also be used to identify the name of the utility company 116 being paid by the customer 112 to enable printing of that name on the customer's receipt.

All or a subset of the information included in the transaction record 220 is supplied by the POS controller 130 to the cashier terminal 126 for printing on a receipt. Although the customer 112 is described herein as paying the invoice 114 at the retail store 118, the customer 112 may additionally purchase products offered by the retail store 118 in the same transaction.

Referring still to the block 320, the transaction record 220 is made available to the payment service company 134 via the communication link 122 and is transmitted between the two entities using a data pull operation or any other operation that effectively results in the transfer of the transaction record 220.

At a block 340, after the payment service processor 138 located at the payment service company 134 receives the transaction record 220, the payment service company 134 uses the customer identification code 148 to determine the identity of the customer 112. For example, the payment service processor 138 accesses the customer identification list 210 (described with reference to FIGS. 1 and 2) using the customer identification code 148 to determine the identity 208 such as, for example, the name of the corresponding customer 112.

Then at a block 342, the payment service processor 138 accesses the customer identification list 210 to identify the utility account number 123 associated with the customer 112. In the event that a customer 112 is using the payment service company 134 to pay invoices 114 issued by two or more utility companies, then the customer identification list 210 further includes information that permits the utility company 116 associated with each of the utility account numbers 123 to be identified. For example, the utility account numbers 123 may be formatted to include digits that uniquely identify the utility company 116 associated with each such utility account number 123. The digits may be implemented in one example as the PLU number 202 of the corresponding utility company 116.

In another example, the payment service processor 138 may access the utility account list 124 stored in the payment service memory 146 to obtain the customer's corresponding utility account numbers 123. As described earlier, the transmission of the utility account list 124 is preferred to aid in the invoice payment process, but not required to enable the invoice payment process described herein. Transmission of the utility account list 124 is not required because the payment service processor 138 can retrieve the utility account number 123 using information supplied by the customer 112 during the enrollment process. In one example, the payment service processor 138 may use the utility account list 124 supplied by the utility company 116 to verify the accuracy of the utility account numbers 123 supplied by each of the customers 112.

Additionally, at the block 342, the payment service processor 138 uses the PLU number 202 or the identity 204 of the utility company 116, either or both of which were supplied in the transaction record 220, to reference the PLU list 206 (shown in FIG. 2) and identify the utility company information 205 stored therein for use in overseeing transfer of funds to the utility company 116. For example, the utility company information 205 that identifies, for example, a billing address of the utility company 116 or a bank account of the utility company 116 is used to ensure that the payment made by the customer 112 is properly transferred to the appropriate utility company 116. It should be understood that the PLU list 206 stored in the retail store processing system 128 may, but need not contain all of the utility company information 205 stored in the PLU list 206 of the payment service processing system 136. In one example, some of the utility company information 205 required to effect fund transfer to the utility company 116 on behalf of the customer 112 can be omitted from the PLU list 206 stored in the retail store processing system 128 because the retail store processing system 128 may have no need for such information.

At a block 344, the payment service processor 138 sends, for example, the name of the customer 112, the utility account number 123, the identity 204 of the utility company 116, the corresponding utility information 205 and the total amount 224 to a bank 152, or other fund processing agent 152, which uses the information to forward the payment amount 226 to the utility company 116 on behalf of the customer 112.

The bank 152 then sends a payment confirmation record to the payment service processor 138 which supplies the payment confirmation record to any, some or all of the utility company 116, the customer 112 and the retail store 118. Additionally, the bank 152 transmits an electronic funds transfer invoice to the retail store 118 and/or to the retail processing center 120 identifying the payment amount 226 plus the service fee 222 to be paid to the payment service company 134. The retail store 118 validates the payment amount 226 and the service fee 222 and then pays the bank 152 an amount equal to the total amount 224 using an electronic funds transfer at a block 348.

At a block 350, the bank 152 receives the total amount 224 and transmits at least a portion of the service fee 222 to the payment service company 134. The bank 152 may also retain a portion of the service fee 222 in exchange for providing the banking services.

There are many methods by which the actual transfer of funds may occur between the bank 152, the retail store 118 and the utility company 116. The specific method described with respect to blocks 344 through 350 are merely intended to illustrate an example of one way in which the transfer may be executed. Any other method that effectively causes the appropriate amount of funds to be transferred to the proper parties may be used in connection with the method of FIG. 3.

As is known by one having ordinary skill in the art, retailers routinely utilize UPC bar-codes stamped or otherwise displayed on products. The UPC bar-codes are scanned by the cashier 119 using the scanner 115 and thereby supplied to the retail store processor 129. The POS controller 130 is programmed to recognize each UPC bar-code as representing the price of the product displaying the scanned UPC bar-code. The UPC bar-code may additionally be used to trigger the retrieval of other information including, for example, a truncated item description, and/or any price variations to be applied to the product such as, for example, sale prices and or discounts, e.g., two products for the price of one discount. Conventional PLU numbers (not shown), in contrast, are used by retailers to identify the price of products that are not amenable to usage of a bar code, including, for example, fruits and vegetables. Such products have varying prices that depend, for example, on the weight of the product being sold and the corresponding cost per unit of weight.

In a typical transaction involving the purchase of a product having a conventional PLU number (not shown), the cashier 119 enters the corresponding conventional PLU number into the cashier's terminal 126 thereby causing it to be supplied to the POS controller 130. The POS controller 130 responds to the conventional PLU number by initiating a conventional PLU process by which the cost of the product is determined. Specifically, the POS controller 130 responds to the PLU number by causing a prompt to be delivered to cashier's terminal 126. The prompt instructs the cashier 119 to enter either: 1) a unit of weight for the product, which is determined by placing the product onto a scale (not shown) that is coupled to the retail store processing system 128, or 2) a count of the total number of associated units that are being purchased. The POS controller 130 then determines the cost of the product by multiplying the weight of the product determined at the scale, or the count entered by the cashier 119, and the product's cost per unit or cost per unit of weight, as applicable. As will be understood by one of ordinary skill in the art, the cashier 119 may have memorized the PLU number 202 corresponding to a specific product such that the cashier 119 need only recall the PLU from memory and enter it into the cashier terminal 126 when the product is encountered. If the cashier 119 does not recall the PLU number corresponding to a product brought to the cashier terminal 126 for purchase, then the cashier 119 may identify the appropriate PLU number by consulting, for example, a printed look up table that lists each product and its corresponding PLU number.

By using specialized PLU numbers 202 that represent, for example, utility companies 116, the payment process described herein is enabled in a way that minimizes the modifications needed to be made to the conventional POS controller 130 and corresponding retail store processing system 128. For example, new equipment need not be added to the retail store processing system 128 nor does the conventional system have to undergo a major redesign. Instead, according to one example embodiment, the operation of the POS controller 130 is modified to recognize the PLU numbers 202 that represent utility companies 116 and to respond to these PLU numbers 202 by initiating the payment transaction process described herein.

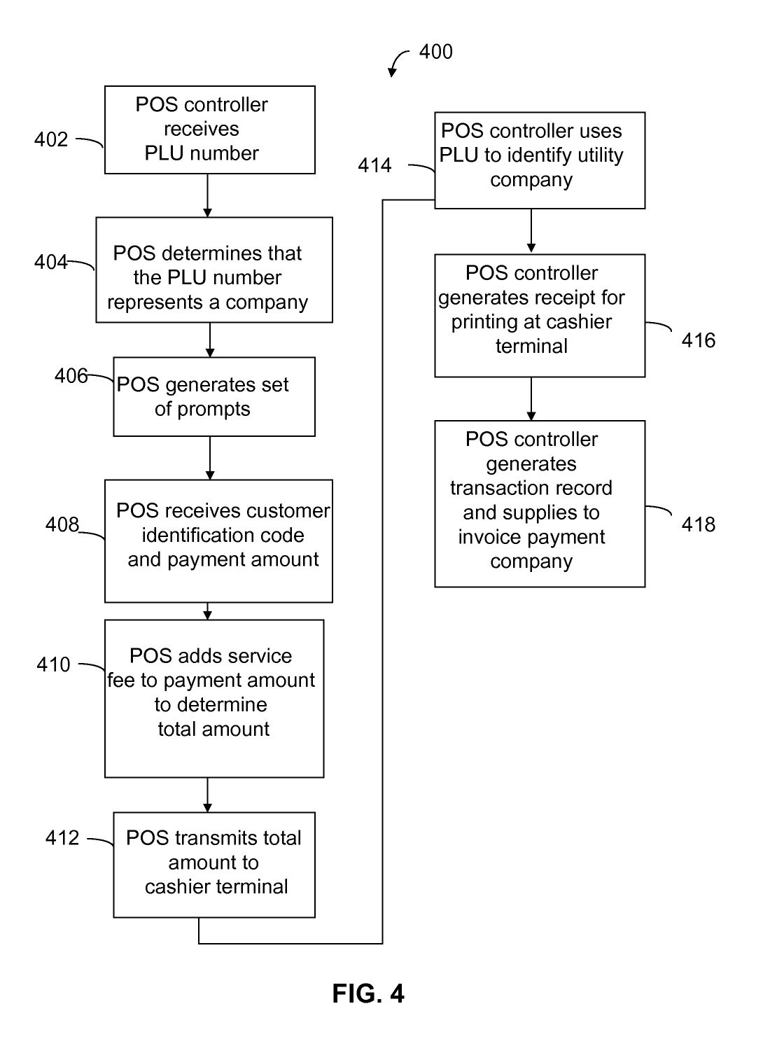

Referring now to FIGS. 1 and 2 and to FIG. 4 a method 400 for modifying the operation of a conventional POS system 128, begins at a block 402 where the PLU number 202 is received by the POS controller 130. Then, at a block 404, the POS controller 130 is modified to recognize the PLU number as a specialized PLU number 202 that corresponds to a utility company 116. The modification causes the POS controller 130 to initiate a set of tasks that enable capture of invoice payment information, as is described further herein. The process by which the POS controller 130 recognizes the special PLU number 202 may be implemented by, for example, causing the POS controller 130 to use the PLU list 206 to determine whether the received PLU number is contained within the PLU list 206.

If the PLU number is not identified in the PLU list 206, then the POS controller 130 treats the PLU number as a conventional PLU number to determine the price of the corresponding product. If the PLU number is recognized as a special PLU number 202, then the method continues at a block 406 at which the POS controller 130 is modified to respond to the recognized PLU number 202 by generating a set of two prompts that are supplied to the cashier 119 via the cashier terminal 126. The first such prompt instructs the cashier 119 to scan or key enter the customer identification code 148 from the UPC bar-code, the alphanumeric character set presented by the customer 112 to the cashier 119, or the code carried in a magnetic strip card embedded on a card. The second such prompt is generated after the UPC bar-code has been scanned or the alphanumeric characters have been key entered and received at the POS controller 130 and instructs the cashier 119 to enter a payment amount 226 representing the amount of money that the customer 112 intends to pay toward the invoice 114. As will be appreciated by one of ordinary skill in the art, the prompt need not provide any instructions per se to the cashier 119, rather the cashier 119 may be trained to understand that the prompt is intended to cause the cashier 119 to enter the required information into the cashier terminal 126.

Next, at a block 408, the POS controller 130 is modified to receive the customer identification code 148 as well as the payment amount 226 which were entered in response to the set of prompts generated at the block 406.

At a set of blocks 410 and 412, the POS controller 130 is modified to add a service fee 222 to the payment amount 226 to determine a total amount 224 to be paid by the customer 112 and to supply the total amount 224 to the cashier's terminal 126 for use in informing the customer 112 of the amount of money to be tendered.

In a further modification to the operation of the POS controller 130, at a block 414, the POS controller 130 accesses the PLU look-up list 206 using the PLU number 202 to identify the corresponding utility company 116. At a block 416, the POS controller 130 is modified to supply all or a subset of the information received and/or determined at the POS controller 130 to the cashier terminal 126 for printing on a customer receipt.

Finally, at a block 418, the POS processor 130 is modified to create a transaction record 220 containing, for example, the identity 204 of the utility company 116, the PLU number 202, the total amount 224 and the customer identification code 148. The transaction record 220 is subsequently supplied to the ftp server 132 which makes the transaction record available to the payment service company 134 using a data pull or data push operation or any other method by which data transmission is performed. The frequency at which transaction records are pulled may occur at any desired interval. The example method 400 is also described in U.S. Publication No. 2009/0198583 entitled, “Method for Paying Invoices” and published on Aug. 6, 2009, which is hereby incorporated by reference in its entirety.

The described modifications may be made to the POS controller 130 using software instructions that are incorporated into the existing check out routines performed by the POS controller 130. By utilizing features and functionality of the existing retail store processing system 128, the invoice payment process can be implemented relatively quickly and simply without need for either major redesign of the retail store processing system 128 or addition of hardware components or system equipment. While several example embodiments have been illustrated and described herein numerous modifications may be performed.

For example, in another embodiment, the retail store 118 and the retail processing center 120 that are shown in FIG. 1 as two separate entities, may instead be co-located. Indeed, the retail processing system 125 and the retail store processing system 128 may be integrated to form a single processing system.

Further, while the invoice 114 paid using the payment transaction is described as being generated by a utility company 116, the invoice 114 may instead be generated by any company that provides services and/or products to the customer 112 at a location that is off-site from the retail store 118 and/or retail processing center 120. Additionally, the utility company 116 is intended to represent any company that provides a utility service to the customer 112 including, for example, natural gas, electric, water, telephone service, both land-based and wireless, e-mail service, cable television service, internet service, and text messaging service, to name a few. Additionally, while the utility company 116 is represented and described with respect to FIG. 1 as having a processing system 121, it should be understood that the utility company 116 also includes infrastructure and natural resources, if applicable, neither of which are shown in FIG. 1, that are needed to supply the utility to the customer 112. Likewise, the retail store 118, retail processing center 120 and payment service company 134 also include infrastructure and equipment (not shown) needed to provide each entity's respective services and/or products.

Although the retail store 118 is described herein as being a grocery store, the retail store 118 may be any retail store 118 having a POS system with UPC bar code scanning capabilities and/or a combination of different types of retail stores. Examples of such retail stores include pharmacies, convenience stores, and clothing stores to name but a few. It is to be understood that, an invoice payment process involving the payment of invoices 114 for these varying types of retail stores may involve collecting different or additional information than what is described herein for use in paying the utility invoice 114.

The financial institution 152 is represented herein by the bank 152. However, the financial institution may be implemented using any institution capable of providing funds transaction management services.

The various lists and tables created to enable the invoice payment process are described as being stored in at least one of the memories 117, 131, 146 and 1258 of FIG. 1. Any of these lists/tables/sets of data may be stored in any of a variety of formats including, but not limited to, in databases, in flat files, or in any other known data storage structure.

Each of the data lists and tables identified in FIG. 2 including the PLU list 206, the customer identification list 210, the transaction record 220, and the utility account list 124 are described as containing specific sets of information/data. However, any of these lists/tables may include a fewer or greater number of fields of information/data and/or the list/tables may be combined in any number of ways. Depending on the manner in which the information is combined, one or more of the lists/tables may no longer be required for enabling the invoice payment process.

Any UPC bar-coded information described herein such as may be formatted using the bar code symbology referred to as UPC-A. Alternatively, the UPC bar-code may be implemented using any available format that is able to be read and recognized by a conventional retail store processing system 128 having a conventional POS controller 130, including two dimensional UPC formats. As will be understood by one of ordinary skill in the art, the UPC bar-code format that is selected for implementation must be recognized and readable by the various components of the system 100 that are configured to use the bar-code formatted information.

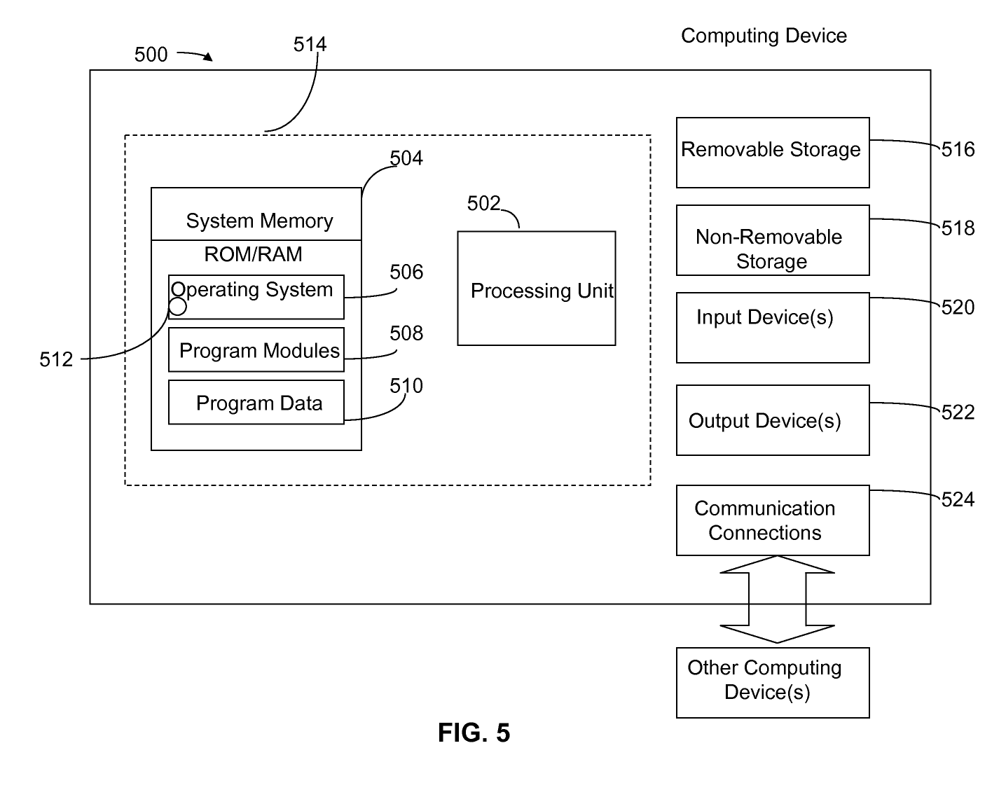

FIG. 5 illustrates a representative computing device 500 that may be used to implement the processing systems described herein. For example, the payment service processing system 136 (see FIG. 1) may be implemented on the representative computing device 500. However, it will be readily appreciated that the various embodiments of the processing systems described herein may be implemented in other computing devices, systems, and environments. The computing device 500 shown in FIG. 5 is only one example of a computing device and is not intended to suggest any limitation as to the scope of use or functionality of the computer and network architectures. Neither should the computing device 500 be interpreted as having any dependency or requirement relating to any one or combination of components illustrated in the example computing device.

In a very basic configuration, computing device 500 typically includes at least one processing unit 502 and system memory 504. Depending on the exact configuration and type of computing device, system memory 504 may be volatile (such as RAM), non-volatile (such as ROM, flash memory, etc.) or some combination of the two. System memory 504 typically includes an operating system 506, one or more program modules 508, and may include program data 510. The operating system 506 includes a component-based framework 512 that supports components (including properties and events), objects, inheritance, polymorphism, reflection, and provides an object-oriented component-based application programming interface (API).

The device 500 is of a very basic configuration demarcated by a dashed line 514. Again, a terminal may have fewer components but will interact with a computing device that may have such a basic configuration.

Computing device 500 may have additional features or functionality. For example, computing device 500 may also include additional data storage devices (removable and/or non-removable) such as, for example, magnetic disks, optical disks, or tape. Such additional storage is illustrated in FIG. 5 by removable storage 516 and non-removable storage 518. Computer storage media may include volatile and nonvolatile, removable and non-removable media implemented in any method or technology for storage of information, such as computer readable instructions, data structures, program modules, or other data. System memory 504, removable storage 916 and non-removable storage 918 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer storage media may be part of device 500. Computing device 500 may also have input device(s) 520 such as keyboard, mouse, pen, voice input device, touch input device, etc. Output device(s) 522 such as a display, speakers, printer, etc. may also be included. These devices are well known in the art and are not discussed at length here.

Computing device 500 may also contain communication connections 524 that allow the device to communicate with other computing devices 526, such as over a network. These networks may include wired networks as well as wireless networks. Communication connections 524 are examples of communication media. Communication media may typically be embodied by computer readable instructions, data structures, program modules, etc.

It is appreciated that the illustrated computing device 500 is only one example of a suitable device and is not intended to suggest any limitation as to the scope of use or functionality of the various embodiments described. Other well-known computing devices, systems, environments and/or configurations that may be suitable for use with the embodiments include, but are not limited to personal computers, server computers, hand-held or laptop devices, multiprocessor systems, microprocessor-based systems, set top boxes, game consoles, programmable consumer electronics, network PCs, minicomputers, mainframe computers, distributed computing environments that include any of the above systems or devices, and/or the like.

While example embodiments have been illustrated and described, numerous modifications may be made to the examples when implementing the invoice payment process. The scope of protection is only intended to be limited by the scope of the accompanying claims, either literally or under the doctrine of equivalents.

What is claimed is:

1. A method for processing a payment of a utility invoice made by a consumer at a retail store, wherein the utility invoice is issued by a utility service provider that provides a utility service to the consumer, the method comprising:
receiving invoice payment transaction information from a retail store, the invoice payment transaction information comprising a consumer identification code corresponding to the consumer and a payment amount to be credited toward the utility invoice;
using the consumer identification code included in the payment transaction information to locate in a database a utility account number by which the consumer is charged for the utility service provided by the utility service provider; and,
causing at least a portion of the payment amount of money to be transmitted to the utility service provider for credit toward the utility account number located in the database.

2. The method of claim 1, further comprising:
associating in the database the consumer identification code with the utility account number.

3. The method of claim 1, wherein the payment transaction information further comprises a utility identifier corresponding to the utility service and wherein the consumer identification code and the utility identifier are used to locate the utility account number in the database.

4. The method of claim 3, further comprising:
associating in the database all of the consumer identification code, the utility identifier and the utility account.

5. The method of claim 3, wherein the utility service is one of a plurality of utility services, the utility service provider is one of a plurality of utility service providers each providing a corresponding one of the utility services to the consumer, the utility identifier is one of a plurality of utility identifiers, each corresponding to a unique one of the utility service providers, the utility account number is one of a plurality of utility account numbers, each used by a corresponding one of the utility service providers to charge the consumer for the corresponding one of the utility services, the method further comprising:
collecting from the consumer a list of the plurality of utility service providers;
using the list of utility service providers to compile a list of corresponding utility identifiers;
collecting a list of the plurality of utility account numbers, each utility account number corresponding to one of the utility service providers to charge the consumer for the corresponding one of the utility services;
associating in the database each one of the utility identifiers with a respective one of the utility account numbers, wherein each one of the utility identifiers and associated one of the utility account numbers correspond to a same utility service provider.

6. The method of claim 3, further comprising:
associating in the database all of the consumer identification code, the utility identifier and the utility account number so that the consumer identification code and the utility identifier can be used to locate the utility account number in the database.

7. The method of claim 1, further comprising:
using the consumer identification code to locate in the database a set of consumer identifying information that comprises a name of the consumer and a contact information for the consumer.

8. A system to process a payment of a utility invoice made by a consumer at a retail store, wherein the utility invoice is issued by a utility service provider that provides a utility service to the consumer, the system comprising:
an input to receive invoice payment transaction information from the retail store, the invoice payment transaction information comprising a consumer identification code corresponding to the consumer and a payment amount to be credited toward the utility invoice;
a database having the consumer identification code and a utility account stored therein, the utility account number representing a utility account used by the utility service provider to charge the consumer for the provided utility service;
a processor to locate the utility account number in the database using the consumer identification code; and,
an output to transmit instructions that cause at least a portion of the payment amount of money to be sent to the utility service provider for credit toward the utility account number.

9. The system of claim 8, wherein the consumer identification code is associated with the utility account number in the database and wherein the processor uses the consumer identification code to find the associated utility account number in the database.

10. The system of claim 8, wherein the payment transaction information further comprises a utility identifier corresponding to the utility service provider and wherein the processor uses the consumer identification code and the utility identifier to locate the utility account number in the database.

11. The system of claim 10, wherein the consumer identification code, the utility identifier and the utility account number are all associated and wherein the processors uses the consumer identification code and the utility identifier to locate the utility account number in the database.

12. The system of claim 10, wherein the utility service is one of a plurality of utility services, the utility service provider is one of a plurality of utility service providers each providing a corresponding one of the utility services to the consumer, the utility identifier is one of a plurality of utility identifiers, each corresponding to one of the utility service providers, the utility account number is one of a plurality of utility account numbers, each used by a corresponding one of the utility service providers to charge the consumer for the corresponding one of the utility services, and wherein the input is a first input, and the processor is a first processor, the system further comprising:
a second input to receive a list of the plurality of utility service providers that service the consumer and a list of the plurality of utility account numbers; and,
a second processor to use the list of utility service providers to compile a list of the corresponding utility identifiers; and
and wherein each one of the utility identifiers is associated with a respective one of the utility account numbers, wherein each one of the utility identifiers and associated one of the utility account numbers correspond to a same utility service provider.

13. The system of claim 12, wherein the first input and the second input are the same input, the first processor and the second processor are the same processor.

14. A tangible, machine readable medium storing machine readable instructions which, when executed, cause a machine to at least:
receive invoice payment transaction information from a retail store, the invoice payment transaction information comprising a consumer identification code corresponding to a consumer and a payment amount to be credited toward a utility invoice;
use the consumer identification code included in the payment transaction information to locate in a database a utility account number by which the consumer is charged for a utility service provided by a utility service provider;
cause at least a portion of the payment amount of money to be transmitted to the utility service provider for credit toward the utility account number extracted from the database.

15. The medium of claim 14, wherein the instructions further cause the machine to:
associate in the database the consumer identification code with the utility account number.

16. The medium of claim 14, wherein the payment transaction information further comprises a utility identifier corresponding to the utility service, wherein the instructions further cause the machine to:
use the consumer identification code and the utility identifier to locate the utility account number in the database.

17. The medium of claim 16, wherein the instructions further cause the machine to:
associate in the database all of the consumer identification code, the utility identifier and the utility account.

18. The medium of claim 16, wherein the utility service is one of a plurality of utility services, the utility service provider is one of a plurality of utility service providers each providing a corresponding one of the utility services to the consumer, the utility identifier is one of a plurality of utility identifiers, each corresponding to a unique one of the utility service providers, the utility account number is one of a plurality of utility account numbers, each used by a corresponding one of the utility service providers to charge the consumer for the corresponding one of the utility services, the instructions further causing the machine to:
collect from the consumer a list of the plurality of utility service providers;
use the list of utility service providers to compile a list of corresponding utility identifiers;
collect a list of the plurality of utility account numbers, each utility account number corresponding to one of the utility service providers to charge the consumer for the corresponding one of the utility services;
associate in the database each one of the utility identifiers with a respective one of the utility account numbers, wherein each one of the utility identifiers and associated one of the utility account numbers correspond to a same utility service provider.

19. The medium of claim 16, the instructions further causing the machine to:
associate in the database all of the consumer identification code, the utility identifier and the utility account number.

20. The medium of claim 16, the instructions further causing the machine to:
use the consumer identification code to locate in the database a set of consumer identifying information that comprises a name of the consumer and a contact information for the consumer.
